(19) United States
(12) Patent Application Publication
(10) Pub. No.: US 2004/0196182 A1
(43) Pub. Date: Oct. 7, 2004

(54) Intelligent mobile asset management system

(76) Inventor: Robert M. Unnold, Stamford, CT (US)

Correspondence Address: MORGAN & FINNEGAN, L.L.P., 345 Park Avenue, New York, NY, 10154-0053, US

(21) Appl. No.: 10/405,704

(22) Filed: Apr. 3, 2003

(51) Int. Cl. G01S 5/14; G08B 23/00

(52) U.S. Cl. 342/357.07; 340/573.1

(57) ABSTRACT

Apparatus, system and method for intelligently tracking and monitoring physical assets worldwide using solar cells, rechargeable battery, two-way satellite communications, a CPU with memory, sensors of various types and GPS in the device and a GIS (Geographic Information System) database for storing and reporting the location and condition of the asset. The apparatus is permanently mounted on the physical asset, e.g., a cargo container, portable construction equipment, etc., where it reports its position and condition to the based unit, based on, movement, a container door being opened, overheating, etc., time passage or on-demand, using satellite communication networks. These reporting criteria are controlled by the system and are set and reset as needed.

### BACKGROUND OF THE INVENTION

1. Field of the Invention

This invention relates generally to an apparatus, system and method for tracking and monitoring movable assets worldwide with very limited or no manual intervention.

2. Prior Art

In conventional tracking systems there is typically a mobile device or unit that is physically attached to the item being tracked. The mobile unit sends data signals to the rest of the tracking system related to the location of the item. The tracking system then uses the received data to accurately determine and report the item's location. Thus, the accuracy of the tracking system is made possible by the data signals that are accurately and continuously received by the mobile unit. To this end, reliability of the mobile unit and communication range of the mobile unit are essential.

In the past, mobile unit reliability was ensured by conducting periodic servicing or maintenance, which generally required the replacement of a battery. Additionally, the mobile unit had to be within a terrestrial based wireless communication system coverage area in order for the data signals to be utilized by the rest of the tracking system. Therefore, conventional item tracking systems have obvious drawbacks related to reliability and range. The following are just some of the more conventional tracking systems available.

U.S. Pat. No. 6,057,779 is directed to a method of controlling access to a movable container that includes storing in a memory a desired geographical location; determining the geographical location of the container; and enabling a locking mechanism to unlock the container if the determined geographical location matches the desired geographical location. An embodiment also includes the use of a global positioning system so that the system is configured to unlock a door if the vehicle is within a predetermined distance of location coordinates.

U.S. Pat. No. 6,421,001 is directed to an object locator system for requesting and obtaining information about the location of an individual animal or moveable object. The locator system includes the use of a lightweight, attached object locator in a region served by a two-way paging system and a global positioning satellite system. The object locator may be selectively activated to conserve power or enabled to respond only when beyond or within a boundary.

U.S. Pat. No. 6, 225,901 is directed to an automated, real-time, reprogrammable monitoring and control system for portable, remote sensors and subjects including one or more portable monitoring units. Each of the portable monitoring units includes a sensor, a location-determining device, and a sensor interface unit. Each sensor interface unit is separately configured to monitor its sensor and to transmit that sensor's data, via a digital wireless communications network, to a central monitoring device. The portable unit is carried or worn by a person or animal, or affixed to an inanimate subject.

U.S. Pat. No. 6,393,360 is directed to a method and apparatus for giving an accurate vehicle location and route from one location to a desired destination. This is accomplished using an LPS (Local Position System) navigation system that has two main units: 1) the address code; and 2) the receiver, which can receive signals on the road and search a database. The database is located in the vehicle and gives the accurate location of the vehicle as well as precise directions to a location based on user input.

U.S. application No. 0020042280 is directed to a triggerable location-reporting apparatus. A trigger signal from a page receiver triggers a GPS receiver to determine the location of the apparatus using GPS signals. The resulting GPS signal is transmitted by a telemetry transmitter, such as a cellular network telemetry transmitter.

U.S. application No. 0020121969 is directed to a monitoring apparatus and method for a vehicle and/or premises, which includes the use of a first, second and third control device. The first control device transmits a first signal to the second control device, which is located at a location remote from said first control device and remote from a vehicle or premises. The second control device then transmits the second signal to a third control device, which is located at the vehicle or premises. The third control device generates a signal that activates, deactivates, enables, or disables a vehicle, premises, vehicle system, system equipment, subsystem, device, component or appliance.

U.S. application No. 002138199 is directed to a global positioning tag system for determining the location of an object that includes an interrogator remote from the object and a transponder located at the object. The interrogator receives GPS signals and transmits pre-positioning data and a tracking signal to the transponder. The transponder collects the pre-positioning data to produce a correlation snapshot. The transponder transmits the correlation snapshot to the interrogator and the interrogator determines the pseudo-range associated with the GPS signal using the correlation snapshot.

Although the prior art noted above can be used to determine the position of an item or object, all seem to suffer from at least one of the deficiencies previously noted; namely reliability of the power system or range of the communications system. Thus, there appears to be a need for a more reliable item tracking system that can consistently and accurately determine the location and condition of an item at any time regardless of movement and then be able to report the information regardless of location.

### SUMMARY

To overcome limitations in the prior art described above, and to overcome other limitations that will be apparent upon reading and understanding the present application, the present invention is directed to an apparatus, system and method for providing reliable and accurate asset tracking and monitoring.

More specifically, the present invention provides a mobile unit that comprises a rechargeable battery, multiple printed circuit boards, multiple antennas, a light responsive recharging means integral with the battery, such as a solar cell, wherein the solar cell, printed circuit boards, and antennas are affixed to, and integral with, the rechargeable battery.

The term “integral,” as used herein describes a particular construction means wherein the members comprising the construction are affixed to one another and are inseparable from one another during normal use. The whole device is encapsulated in a protective coating that is transparent over the solar cell and significantly durable to prevent accidental penetration of the encapsulation. The device is secured to the asset to be monitored in a permanent fashion, e.g., welded.

One advantage provided by an embodiment of the invention is that the solar cell and rechargeable battery can power a GPS receiver (a module that receives signals from the global positioning system satellites and calculates where the module is to within several meters), a satellite pager (a module that provides digital communications via satellites to and from the control system), various sensor devices (a module and a variety of sensors where the attributes of the asset to which the device is permanently mounted are determined, e.g. temperature in the container, door open or closed, movement in progress, etc.) and a central processing unit (a circuit board that processes the information obtained from the GPS module, the various sensors and the base unit as received via the satellite pager to determine what action further sensing or reporting action to take) for multiple years at the required level of output for an active system without physically replacing the battery.

A second advantage is that the base unit is in communication with the mobile unit via a worldwide communication network to receive data from the mobile unit for processing. The communication network is, for example, a satellite network. The data is received from a plurality of sensors used by the mobile unit to detect the location and condition of an asset. The base unit compares the data received from the mobile unit with previously stored or currently obtained data to determine if the asset is where it should be and in an acceptable condition. In the event that the conditions are not acceptable, i.e., the asset is in motion and it should not be, the base system provides an alarm or indication to the operator of the base unit. In the event that all conditions are within the parameters established the base unit logs the report and either adjusts the data reporting criteria or sets its own parameter as to when the next report should be received by the base unit.

Another advantage of the present invention is to store, display and report the data provided by the mobile unit to the base unit using a GIS presentation and to control the mobile unit functionality via satellite communication.

Another advantage of the present invention is that the mobile unit includes the use of a local radio and antenna operable to allow the mobile unit to receive information in the form of data or operating instruction from a wireless, hand-held unit. The local radio and antenna employs 802.11, Bluetooth or other similar short-range communication protocol.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

The accompanying figures best illustrate the details of the apparatus, system and method for implementing the asset management system of the present invention.

FIG. 1 is a diagram of the apparatus and system in accordance with an embodiment of the present invention.

FIG. 2 is a flowchart illustrating a method of implementing the apparatus and system in accordance with an embodiment of the present invention.

FIG. 3 is a flow chart illustrating a method of remote updating in accordance with an embodiment of the present invention.

FIG. 4 is a flow chart illustrating a method of local updating in accordance with an embodiment of the present invention.

### DETAILED DESCRIPTION OF THE PREFERRED EMBODIMENTS

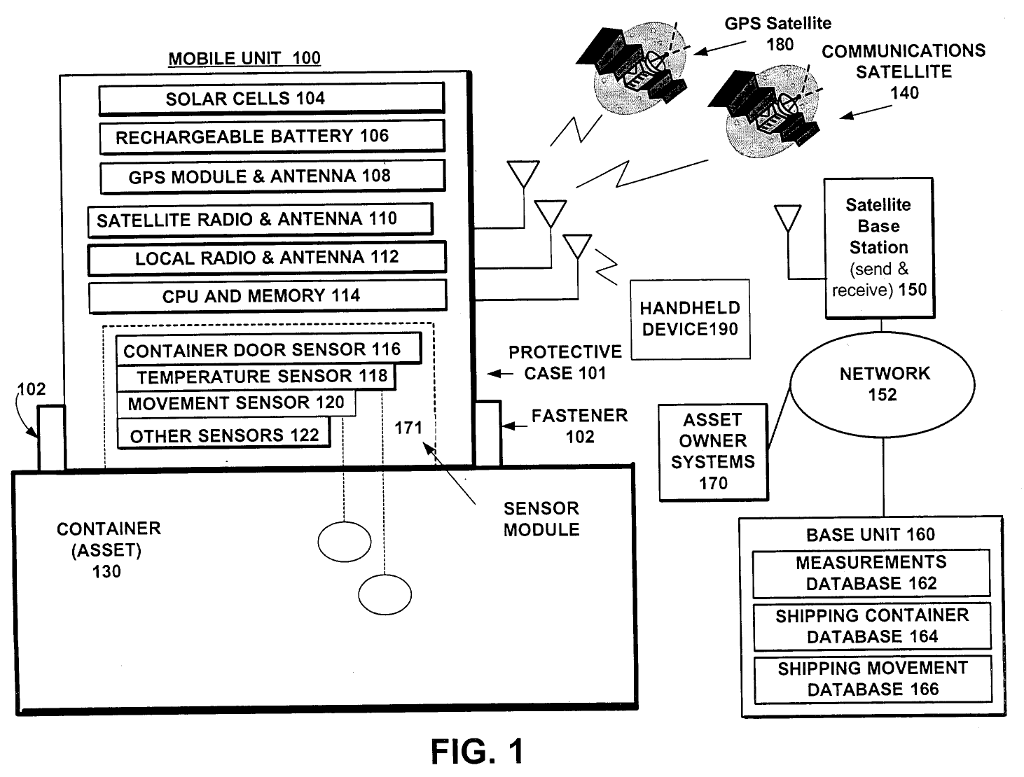

FIG. 1 is a diagram of the management asset apparatus and system in accordance with an embodiment of the present invention. The apparatus of the present invention is a mobile unit 100 that includes, in pertinent part, a solar cell 104, rechargeable battery 106, GPS module and antenna 108, satellite radio and antenna 110, local radio and antenna 112, CPU and memory 114 and a sensor module 171. The components of the mobile unit are encapsulated in a protective coating or case 101 that is transparent over the solar cell 104 and significantly durable to prevent accidental penetration of the encapsulation. The mobile unit 100 is secured to the asset 130 to be monitored in a permanent fashion using a fastener 102, or other method for permanently fixing the mobile unit 100 to an asset or asset container 130 such as, but in no way limited to, a weld.

The solar cell 104 is a light responsive recharging means integral with the rechargeable battery 106 for providing a continuous charge to the battery 106. The term “integral,” as used herein describes a particular construction means wherein components are affixed to one another and are inseparable from one another in normal use. The term “continuous” as used herein contemplates that the invention is periodically exposed to natural daytime light so that the solar cell 104 becomes energized for charging of the battery 106.

The rechargeable battery 106 provides as the powering system for the mobile unit 100 and is integral with and capable of providing adequate power to the GPS module and antenna 108, the satellite radio and antenna 110, local radio and antenna 112, the central processing unit 114 and the sensor module 171. The rechargeable battery is provided continuous charging by the solar cells 104 and therefore does not require replacement under normal operating conditions of the mobile unit 100.

The global positioning system (GPS) module and antenna 108 receives signals from global positioning system satellites 180 and calculates where the module is located within several meters. The satellite radio and antenna 110 provides digital data communications between the mobile unit 100 and a base unit 160 via a satellite 140, satellite base station 150 and network 152. The local radio and antenna 112 provides for wireless communication between the mobile unit 100 and a hand-held device 190. The local radio and antenna 112 employs 802.11, Bluetooth or other short-range data communication protocols.

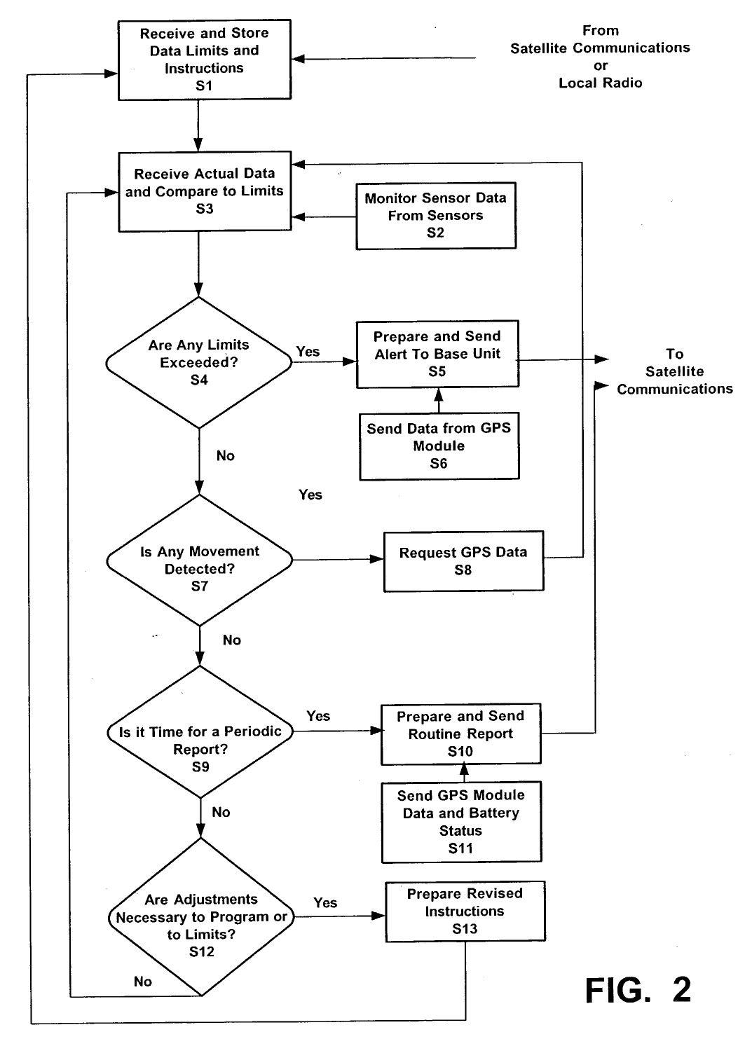

The CPU and memory 114 provide the control system for the mobile unit 100. The CPU and memory 114 performs a self-check of the mobile unit's functions and periodically reports the condition of the mobile unit 100 and its components as well as reports alarm conditions when they exist. For example, the CPU and memory 114 receives and maintains asset limits or parameters with regard to the expected condition and movement of the asset 130 being tracked. The CPU and memory 114 periodically takes measurements from sensors in the sensor module 171 and the GPS module 108. The CPU and memory 114 then compares the measured output data with the stored asset parameters to determine if any of the asset parameters have been exceeded. If so, the CPU and memory 114 will gather the current data and prepare a coded message that includes alarm data, GPS provided coordinates, time/date and other information appropriate for reporting the location and condition of an asset 130 being tacked. Other operations performed by the CPU and memory 114 will be discussed in more detailed in the description of FIGS. 2-5.

The sensor module 171 contains information regarding a variety of sensors such as, but not limited to, a container door sensor 116, temperature sensor 118, movement sensor 120 as well as other sensors 122 (e.g., moisture, humidity, smoke, shock, etc,) that help to provide information regarding the condition of the asset 130 being tracked. The sensors 116, 118, 120, 122 are attached to the container or the asset at various locations so as to receive the most accurate readings or data from the sensors 116, 118, 120, 122. For example, the door sensor 116 may be located somewhere on the inside of the door of the asset container 130 that would give the best indication that the door was open or closed, such as in the doorjam or near the door closing mechanism. Similarly, the temperature sensor 118 may be a probe that is inserted into the container to receive the best indication of the temperature of the asset 130.

The system of the present invention includes, in pertinent part, the mobile unit 100 attached to an asset 130 to be tracked, a GPS satellites 180, a satellite communication system 140, 150 a network 152 and a base unit 160.

As previously stated, the mobile unit 100 will be attached to the asset or container 130 to be tracked and have all the capabilities as noted above. The GPS satellites 180 will provide longitude and latitude information to the mobile unit 100 via the GPS module 108 of the mobile unit 100. The mobile unit 100 can then use the information from the GPS satellite 180 to calculate movement of the asset 130. The communication satellite 140 provides for a communication session between the mobile unit 100 and the base unit 160 via the satellite radio and antenna 110, the communication satellite 140, satellite base station 150 and network 152. Generally, all communication between the mobile unit 100 and the base unit 160 will be implemented through the satellite communication system 140, 150, unless a local connection is in use (e.g., local radio and antenna 112). It is contemplated by the invention that the network 152 may be, but is not limited to, the Internet. Thus, the network connection between the satellite base station 150 and the network 152 as well as the connection between the network 152 and the base 160 can be any suitable connection for the networks list above, such as for example a standard modem connection.

The base unit 160 may be a computer system, PC or server that includes a processor (not shown), and several databases that enables the base unit 160 to perform storing, tracking and processing of data related to the movement and condition of an asset 130. For example, the databases may include a measurement database 162, a shipping container database 164 and a shipping movement database 166. The measurement database 162 stores data measurements reported by the mobile unit 100. The shipping container database 164 stores administrative, historic and system data related to the asset or asset container 130. The shipping movement database 166 stores data related to the movement of the asset or asset container 130.

The base unit 160 receives data from the mobile unit 100 regarding the actual measurements taken with regards to asset conditions or asset movement. The base unit 160 processes all the data and determines when an alert or alarm should be sent to the base unit administrator or asset owner. Additionally, the base unit 160 receives and processes the periodic reports from the mobile unit 100, compares the data reported to the measurement data and determines if any notices are required or if adjustments to data limits or parameters used by the mobile unit 100 should be made. Adjustments to data limits or parameters used by the mobile unit 100 for determining reporting requirements can also be requested by an asset owner. For example, the base unit 100 can receive instructions from an asset owner system 170 to make an adjustment to the data limits or parameters related to an asset 130 being tracked. The base unit 160 stores the new values and then communicates the new values to the mobile unit 100 via the communication networks 140, 150, 152. The data limits or parameters used by the mobile unit 100 can also be adjusted by an asset owner using a hand-held device 190 via the local radio antenna 112 in the mobile unit 100. The hand-held device 190 can be used to initiate testing and onsite tuning of the mobile unit 100. When testing and tuning the mobile unit using the hand-held device, the hand-held device can receive test output data and display the data for analysis by an operator.

FIG. 2 is a flowchart illustrating a method of implementing the asset management apparatus and system in accordance with an embodiment of the present invention. It is contemplated by the invention that the mobile unit 100 is attached to an asset 130 to be tracked. Typically, the mobile unit 100 will perform a self-check of all functions and sensors 116, 118, 120, 122 used by the mobile unit 100, the performance of the solar cell 104 and the state of the battery 110. The status of the mobile unit 100 and its components are periodically reported to the base unit 160 via the communication networks 140, 150, 152.

In step S1, the mobile unit 100 receives data limits parameter from the base unit 160 via the communication networks 140, 150, 152 or the hand-held device 190 via the local radio and antenna 112. In step S2, the CPU and memory 114 of mobile unit periodically monitors and takes measurements from the sensors 116, 118, 120, 122. In step S3, the CPU and memory 114 then compares the actual data received from the sensors 116, 118, 120, 122 with the data limits received from the base unit 160 and stored in the CPU and memory 114.

If data limits are exceed S4, then in step S5 the CPU and memory 114 gathers the current data and prepares a coded message that includes alarm data, GPS location data S6, time/data data as well as other data important for determining the condition and location of the asset. Also in step S5, the CPU and memory 114 initiates and sends the message transmission to the base unit 160 via the communication networks 140, 150, 152 for processing. In step S7, if no data limits are exceeded then the CPU and memory 114 determines if any motion is detected by the sensor 120. If motion is detected, then in step S8 GPS data is requested from the GPS module and antenna 108. The data related to movement of the asset 130 is then transmitted to the base unit 160 for storage and processing. In step S9, if no movement of the asset is detected, then the CPU and memory 114 will determine if periodic status reporting of the mobile unit 100 and the asset 130 should be made to the base unit 160. In step S10, the CPU and memory 114 prepares a routine report related to the status of the mobile unit 100 and the asset 130 and transmits the data to the base unit 160 via the communication networks 140, 150, 152. In step S11, data is sent to the base unit 160 that includes, but is not limited to, information regarding the location and status of the asset 130 and rechargeable battery 106.

In step S12, the CPU and memory 114 analyzes the data received from all sources and determines if any adjustments are necessary to the application programs used by the CPU and memory 114, for example but not limited to if the battery reports a low power condition the application programs maybe adjusted to run routine reports less frequently. If adjustments are necessary then in step S13, the CPU and memory 114 makes the necessary adjustments. It is contemplated by the invention that adjustments to the mobile unit 100 functionality can be implemented via the base unit 160, hand-held device 190 or by the CPU and memory 114 itself.

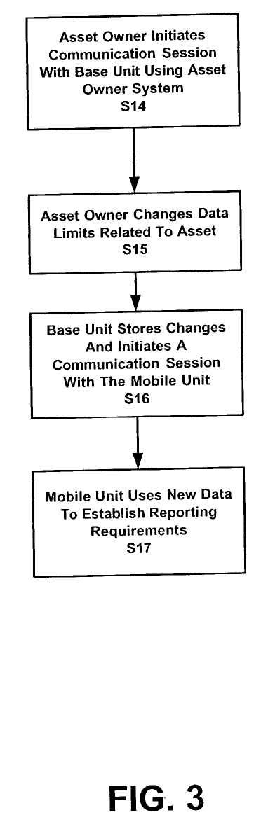

FIG. 3 is a flow chart illustrating a method of remote updating in accordance with an embodiment of the present invention. In step S14, an asset owner 170 initiates a communication session with the base unit 160 via the network 152. The connection between the asset owner system 170 and the network 152 may be a standard network connection such, but not limited, a standard modem connection. In step S15, the asset owner request changes to the data limits or parameter related to the condition and location of an asset from an asset owner computer system 170. For example, an owner may want to narrow or broaden the acceptable range of movement by an asset 130 so as to either increase or decrease the receipt of alarms or alerts from the base unit 160.

In step S16, the base unit 160 stores the requested changes to the data limits related an asset in the appropriate database 162, 164, 166. The base unit 160 then initiates a communication session with the mobile unit 100 via the communication network 140, 150, 152. In step S17 the mobile unit stores the new data limits for determining future reporting requirements to the base unit 160.

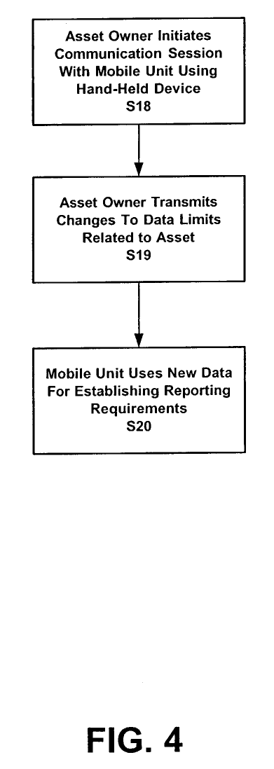

FIG. 4. is a flow chart illustrating a method of local updating in accordance with an embodiment of the present invention. In step S18, an owner initiates a communication session directly with the mobile unit using a hand-held device 190. It is contemplated by the invention that he hand-held device is a wireless device that communicates with the mobile unit via the local radio and antenna 112 in the mobile unit 100. It is also contemplated by the invention that the local radio and antenna 112 of the mobile unit is capable of 802.11, Bluetooth or other short-range communication protocol. In step S19, the asset owner transmits the changes to the data limits for the asset to the mobile unit 100. In step S20, the mobile unit stores the new data parameters for determining if a data alert or alarm message is required and forwards the new data parameters to the base unit 160.

Although illustrative embodiments have been described herein in detail, it should be noted and understood that the description and drawings have been provided for purposes of illustration only and that other variations both in form and detail can be added thereupon without departing from the spirit and scope of the invention. The terms and expressions have been used as terms of description and not terms of limitation.

What we claim is:

1. An intelligent asset tracking and monitoring apparatus comprising: a solar cell, a rechargeable battery, a Global Positioning System (GPS) receiver, a satellite communications module, at least one sensor and a central processing unit (CPU) with memory integrated into one physical unit in a protective casing, which is attached to an asset to be tracked and monitored.

2. The apparatus of claim 1, wherein said solar or photovoltaic cell recharges said rechargeable battery.

3. The apparatus of claim 2, further comprising a feedback circuit wherein the battery charge level is reported to the CPU on demand or periodically reported to the CPU.

4. The apparatus of claim 1, wherein the GPS receiver determines the position of the device using latitude and longitude measurements, and then reports the position to the CPU on demand.

5. The apparatus of claims 1, wherein the satellite communications module is operable to allow the CPU to send and receive information in the form of data or operating instructions.

6. The apparatus of claim 1, further comprising a local radio and antenna operable to allow the CPU to send and receive information in the form of data or operating instructions.

7. The apparatus of claim 6, wherein the local radio and antenna employs 802.11, Bluetooth or other similar short range communication protocol for communicating data to and from the mobile unit.

8. The apparatus in accordance with claim 1, further comprising a sensor module that includes a variety of sensors that detect and report information regarding the status of the asset to which the device is attached.

9. The apparatus of claim 8, wherein said variety of sensors include: a temperature sensor to detect the temperature of the asset, a open and close switch sensor to detect if a doors is open or closed on the asset when the asset is a container, a motion sensor to detect general movement of the asset, and a shock or tamper sensor to detect if the integrity or security of the asset is being compromised.

10. An intelligent system for tracking and monitoring an asset, comprising: a mobile unit attached to an asset; a base unit physically separate from the mobile unit; and a communication network for communicating between said mobile unit and said base unit, wherein the base unit receives data from the mobile unit on demand or based on a predetermined event at the asset level and processes the data to track the asset location and monitor its condition, and wherein the base unit sends data and instructions to the mobile unit as to how to track and monitor the asset.

11. The system of claim 10, wherein the base unit comprises a computer system, PC and/or server.

12. The system of claim 10, wherein the base unit further comprises a measurement database for storing acceptable limits for the asset's condition; shipping container database for storing administrative, historic and mobile asset management data related to the asset; and a shipping movement database for storing data related to acceptable asset movement.

13. The system of claim 10, wherein the mobile unit comprises: a solar cell, a rechargeable battery, a Global Positioning System (GPS) receiver, a satellite communications module, a local radio and antenna, at least one sensor and a central processing unit (CPU) with memory.

14. The system in claim 10, wherein the base unit receives, processes and stores information concerning the asset from an asset owner system via a network.

15. The system of claim 10, wherein said base unit adjusts the reporting requirements for given circumstances or event by sending a data message to the mobile unit via the communication network.

16. The system of claim 10, a wireless, hand-held device adjusts the reporting requirements for given circumstances or event by sending a data message to the mobile unit via a local radio and antenna connection.

17. The system of claim 10, wherein the communication network is a satellite network that establishes a communication session to the base unit via at least one network.

18. The system of claim 14 or 17, wherein the network is the Internet, Intranet or the like.

19. The system of claim 16, wherein the local radio and antenna uses 802.11, Bluetooth or other short range communication protocol for sending data to and receiving data from the mobile unit.

20. The system of claim 10, wherein the base unit determines the asset is in motion by comparing a series of GPS readings, the readings having been triggered by at least one sensor at the device level, the base unit then compares the readings to the expected GPS data, provides a report, displays the asset location on a geographic map, and stores the data in a GIS database.

21. An intelligent method for tracking and monitoring an asset, comprising: attaching a mobile tracking and monitoring unit to an asset to be tracked and monitored; detecting if an asset is in motion or if an event or condition has occurred at the asset level; comparing measured data related to the asset movement, event or condition at the asset level with expected data stored in the mobile unit, communicating between the mobile unit and the base unit; transmitting information related to the location or condition of the asset to a base unit; and determining what action should be taken with regard to the asset.

22. The method in claim 21, further comprising receiving, processing and storing in the base unit information concerning the asset from an asset owner's system via a network connection.

23. The method of claim 21, further comprising adjusting the reporting requirements for an event or circumstance by sending a data message to the mobile unit from the base unit via a communication network.

24. The method of claim 21, further comprising adjusting the reporting requirements for an event or circumstance by sending a data message to the mobile unit from a wireless, hand-held device.

25. The method of claim 23, wherein the communication connection is through a satellite and network to the base unit.

26. The method of claim 22, wherein the network is the Internet, or the like.

27. The method of claim 21, wherein the base station unit determines the asset is in motion by comparing a series of GPS readings, the readings having been triggered by at least one sensor at the device level, the base unit then compares the readings to the expected GPS data, provides a report, displays the asset location on a geographic map, and stores the data in a GIS database.

28. The method of claim 21, further comprising maintaining and reporting the power level of a mobile unit rechargeable battery, wherein the battery is charged by at least one solar cell integral with the mobile unit.
